(19) United States
(12) Patent Application Publication
(10) Pub. No.: US 2010/0138808 A1
(43) Pub. Date: Jun. 3, 2010

(54) EMBEDDED SYSTEM DESIGN DEVICE AND A METHOD THEREOF USING A TARGET INDEPENDENT MODEL

(75) Inventors: Wooyeol Kim, Suwon-si (KR); Robertyoungchul Kim, Glenview, IL (US); Hyungseung Son, Dangjio-gun (KR); Ducksoo Lim, Dajeon (KR)

Correspondence Address: LEXYOUME IP GROUP, LLC, 5180 PARKSTONE DRIVE, SUITE 175, CHANTILLY, VA, 20151, US

(73) Assignees: Wooyeol KIM, Suwon-si (KR); Robertyoungchul KIM, Glenview, IL (US); Hyunseung SON; KMC ROBOTICS CO., LTD., Daejeon (KR)

(21) Appl. No.: 12/484,299

(22) Filed: Jun. 15, 2009

(30) Foreign Application Priority Data
Dec. 2, 2008 (KR) 10-2008-0120892

(51) Int. Cl. G06F 9/44

(52) U.S. Cl. 717/104

(57) ABSTRACT

The present invention provides an embedded system design device and a method thereof using a target independent model comprises: a target independent model expressed in UML diagram type as a resource; a target independent model definition language for expressing the target independent model in language type; a profile where specific data for substantially controlling a particular embedded system is stored; a middle language configured by inserting contents of the profile into the target independent model definition language; a conversion language configured in the same linguistic type as the middle language, and for adding new data which does not exist in the middle language, or for changing particular contents; a target dependent model definition language generated by applying the conversion language to the middle language; and a modeling tool for performing a series of processing procedures of writing a diagram by using a UML (Unified Modeling Language), providing an interface tag which suggests resource items for extracting/generating the target independent model, and generating the target independent model to convert the independent model into the target dependent model.

### BACKGROUND OF THE INVENTION

1. Field of the Invention

The present invention relates to an embedded system design device and a method thereof using a target independent model, and more specifically to an embedded system design device and a method thereof using a target independent model for developing an embedded system regardless of particular hardware, operating system and middleware, and for actively supporting software reuse to employ reused software for development, by separating/designing an independent model from a dependent model in hardware, an operating system, and middleware in case of embedded system development of a new product.

2. Description of the Related Art

An embedded system refers to a solution for conducting a particular task within a certain product, by being additionally mounted on the certain product or a solution.

As for development of the embedded system, a ‘reuse technology of different kinds of software’ for reusing elements commonly necessary between products belonging to a similar product group can bring innovation to embedded system software development, rather than newly and completely developing an embedded system to be built in a particular product.

However, a prior general embedded system is dependent on particular hardware. So, in case of embedded system development of different products, reuse of the aforementioned common elements is not possible. Furthermore, since the particular hardware is already determined, suitable software can be developed only when hardware specification is identified, resulting in problems such as a very inefficient development process of the embedded system and a long development period.

Particularly, a prior embedded system development technology for a robot still reuses codes, and a lot of product lines are utilized to reuse software. Though these product lines can increase a reuse rate of software of one product group, there are no measures for different systems. Thus, it is difficult for software to be applied to hardware products which are quickly changing.

### SUMMARY OF THE INVENTION

It is therefore an object of the present invention to provide an embedded system design device and a method thereof using a target independent model for providing an environment that can actively support reuse of an existing embedded system, when another improved new product is developed from a previously existing particular product, by extracting/generating a target independent model which is not dependent on particular hardware, middleware, and operating system, and by separating/designing a target dependent model from the target independent model of the present invention for converting the target independent model into the target dependent model embodied to realize the particular product to be newly developed.

To accomplish the above object, an embedded system design device and a method thereof in accordance with the present invention comprises: a target independent model expressed in UML diagram type as a resource, which extracts, abstracts, and expresses an upper concept that includes specific functions and contents individually represented in hardware, middleware, and an operating system(hereinafter, target) of a product; a target independent model definition language for expressing the target independent model in language type, for conversion of the target independent model and data storage; a profile where specific data for substantially controlling a particular embedded system is stored; a middle language configured by inserting contents of the profile into the target independent model definition language; a conversion language configured in the same linguistic type as the middle language, and for adding new data which does not exist in the middle language, or for changing particular contents; a target dependent model definition language generated by applying the conversion language to the middle language; and a modeling tool for performing a series of processing procedures of writing a diagram by using a UML (Unified Modeling Language), providing an interface tag which suggests resource items for extracting/generating the target independent model, and generating the target independent model to convert the independent model into the target dependent model.

An embedded system design device and a method thereof using a target independent model in accordance with the present invention have the following remarkable effects:

1) Through separative design of a target dependent model and a target independent model of the present invention for extracting/generating the target independent model which is not dependent on particular hardware, middleware and operating system, and for converting the target independent model into the target dependent model embodied to realize a particular product to be newly developed, it is possible to actively support reuse of an existing embedded system when another improved new product is developed from a previously existing particular product, and to progress development of an embedded system even though a software platform and hardware specification to be applied to a product to be developed are not identified, thereby offering an environment that can quickly and safely develop the embedded system.

2) As model design is conducted by using a UML marking method, existing application developers can also participate in robot development while codes can be automatically generated even by the model design only, making low-level controlling possible.

3) Since a model designing method using a UML can offer a standard marking method, cooperative works and communications are available during development of software, thereby reducing program errors and distributing tasks to enable stable development consequently.

4) A part dependent on hardware, middleware, and an operating system is separately designed from a part which is not dependent thereon, thus expansion is available without a cilent's modification. Accordingly, specific contents for realizing a particular target, that is, target dependent parts can be profiled to generate a detailed realization unit of the target through an automation process.

Therefore, problems of an existing method depending on a system designer's experience or ability can be solved through an automated method, supporting that anyone can easily develop a system once learning a simple design method. Also, since the system is configured by complying with dualized design principles, maintenance can be easily conducted.

5) When a tool is developed, a model engine that draws a diagram of a target independent model can be separated from a compiler part taking charge of conversion, thus development is possible in module unit. Moreover, maintenance is also easy thanks to the independent separation between the model engine and the model compiler.

### BRIEF DESCRIPTION OF THE DRAWINGS

The advantages of the invention wil become readily apparent to those skilled in the art from the following detailed description of a preferred embodiment when considered in the light of the accompanying drawings, in which:

FIG. 1 is a block flowchart showing a series of conversion processes for generating a code that can execute a substantial operation of an embedded system built in a particular product, by creating a hardware-dependent ‘target dependent model’ with the use of a hardware-independent ‘target independent model’ during development and design of an embedded system;

FIG. 2 shows a usage example of a modeling tool and an interface tag provided from the modeling tool in accordance with the present invention;

FIG. 3 is an embodiment of each diagram included in a modeling tool used when a target independent model and a target dependent model in accordance with the present invention are generated;

FIG. 4 is a diagram showing one example of a target independent model generated by using a class diagram of a modeling tool, for design of an embedded system to be built in a robot;

FIG. 5 shows one example of a profile corresponding to a file, where detailed data on realization units corresponding to each hardware defined in an interface tag is stored;

FIG. 6 is a diagram showing a figure that a particular model and a model definition language are mutually converted, to help understanding of a ‘model’ of the present invention and a ‘model definition language’ defined by representing the model in a linguistic way;

FIG. 7 is a diagram showing one example for applying a conversion language of the present invention; and

FIG. 8 is one example for expressing a target dependent model of an embedded system built in a robot, in UML diagram.

### DETAILED DESCRIPTION OF PREFERRED EMBODIMENTS

An embedded system design device and a method thereof using a target independent model in accordance with the present invention are provided to magnify efficiency and convenience of development of an embedded system built in various modern electronic devices such as robots, home appliances, portable terminals and others. That is to say, a core aspect of the present invention is as follows. Through separative design of a target dependent model and a target independent model of the present invention for extracting the target independent model which is not dependent on particular hardware, middleware and operating system, and for converting the target independent model into the target dependent model embodied for a particular product to be newly developed, it is possible to actively support reuse of an existing embedded system when another improved new product is developed from a previously existing particular product.

Before an embedded system design device and a method thereof using a target independent model of the present invention are explained, particular hardware, middleware, and operating system applied to a particular product by being embodied to realize an embedded system of a previously existing particular product will be hereinafter called a ‘target’.

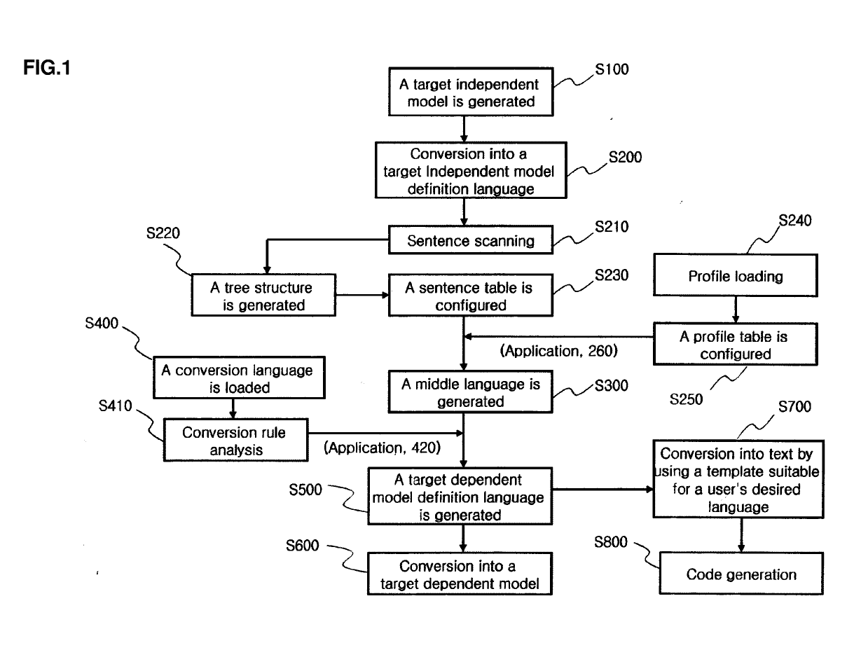

FIG. 1 is a block flowchart showing a series of conversion processes for generating a code that can execute a substantial operation of an embedded system built in a particular product, by creating a ‘target dependent model’ dependent on a target of the particular product, with the use of a ‘target independent model’ which is not dependent on a particular target during development and design of the embedded system.

An embedded system design device and a method thereof using a target independent model in accordance with the present invention separately design a dependent part and a part which is not dependent on the particular target by using the modeling tool.

Namely, when an embedded system of a new product is developed, the target independent model of the present invention is generated and extracted from a target used in another product of a product group to which the new product belongs, and an embodied part for realizing the new product, that is, a target dependent part is easily added to the generated target independent model. Therefore, once the target independent model is converted into the target dependent model in accordance with the present invention, the embedded system for the new product can be designed and completed.

Accordingly, the target independent model can be reused even in case of development of embedded systems of different products, thereby very quickly and easily developing and designing an embedded system to be built in a new product.

From now on, for specific explanation of an embedded system design device and a method thereof using a target independent model in accordance with the present invention, a designing method of an embedded system built in a ‘robot’ will be described as an example.

Referring to FIG. 1, a process up to generate a realization code for executing a substantial operation of an embedded system to be built in a particular product by using a ‘target independent model’ in accordance with the present invention will be described below.

(1) A step of generating the ‘target independent model’ (S100)

First, a term ‘target’ used from now on refers to particular hardware, middleware and operating system applied to a particular product by being embodied to realize an embedded system of the previously existing particular product, and a ‘model’ indicates a type that expresses the target independent model of the present invention in UML diagram by using the modeling tool.

The ‘target independent model’ of the present invention means a model that extracts and abstracts an upper concept including specific realization contents and functions individually represented in the hardware, the middleware, and the operating system, and that expresses the extracted/abstracted upper concept in UML diagram type. Thus, the target independent model is applied to various targets without depending on hardware, middleware, and an operating system (hereinafter, target), and these targets can recognize contents of the target independent model.

In other words, a designer who wants to develop an embedded system to be mounted on a new product can generate the target independent model by easily bringing it from a target of a previously existing product, and complete the target dependent model of the present invention by filling the generated target independent model with a detailed realization unit (that is, data used for realization only of a particular target by being dependent on the particular target) only, thereby conveniently and efficiently designing the embedded system to be mounted on the newly developed product.

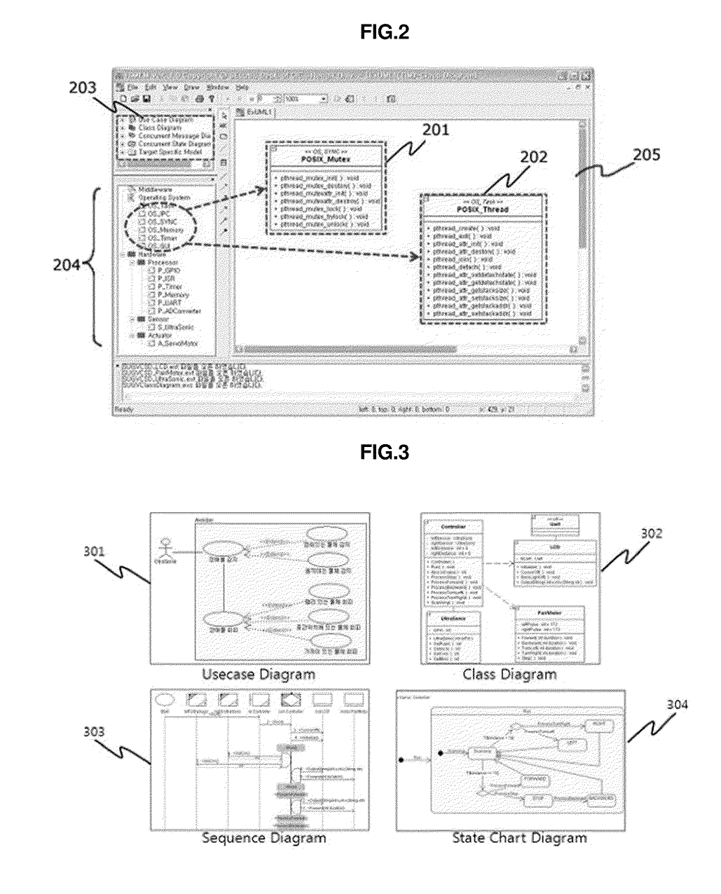

One example for abstracting detailed functions individually represented in the hardware, the middleware and the operating system will be more specifically described in reference to FIG. 2.

FIG. 2 is a diagram illustrating a modeling tool of the present invention, and wherein resource items provided by abstracting targets suggested in a reference code ‘204’ of FIG. 2 and detailed items for more specifically abstracting the resource items, which are expressed in UML diagram type by using the modeling tool, correspond to target independent models of the present invention.

Namely, the ‘target independent models’ of the present invention include processor, sensor, actuator resources for abstracting information expressed in hardware applied to a previously existing robot product, and P_GPIO, P_ISR, P_Timer, P_Memory, P_UART and P_ADConverter resources for more specifically abstracting a processor used for the processor resource, as well as ‘OS_Task’, ‘OS_IPC’, ‘OS_SYNC’, ‘OS_Memory’, ‘OS_Timer’ and ‘OS_GUI’ resources for abstracting information expressed in an operating system applied to the previously existing robot product.

That is to say, the above resources commonly necessary and used for the same product group by being generated in UML diagram type with the use of the modeling tool of the present invention become the ‘target independent models’ of the present invention.

In other words, when a model is not dependent on a particular target, it means that a realization code specifically expressed to be suitable for particular hardware to substantially control the particular hardware is not included, and that the model is configured in interface type only so as to be properly converted into the particular hardware once the particular hardware is determined.

So, when the target independent models are prepared, two methods are used: one is to reuse already-made target independent models, that is, existing target independent models brought from another product of a product group to which a designer's desired product belongs; and the other is to prepare the models by using the modeling tool(UML diagram).

(1-1) A method of reusing and making an existing target independent model is a type that takes out the existing target independent model after storing it and uses the taken model immediately, having an excellent advantage of very quickly and easily designing an embedded system to be built in a new product, since the existing target independent model can be reused during development of embedded systems of products belonging to a similar product group.

(1-2) A method of making the model by using the modeling tool (UML diagram) specifically refers to a method of making the model by employing an interface tag that supports a profile. That is to say, this method using the interface tag employs a previously existing profile.

When the above interface tag is adopted, a predetermined module (that is, a module used for another product) can be easily brought and reused, thereby enabling faster development than an existing method (that is, a method of redesigning or reusing a code). Also, since the model is configured by an interface only regardless of a part dependent on a particular target, it can lower complexity.

FIG. 2 shows a usage example of the modeling tool and the interface tag provided from the modeling tool in accordance with the present invention.

Referring to FIG. 2, the modeling tool comprises: a digram tool(203) for individually suggesting a usecase diagram for design of the target independent model, a class diagram, a sequence diagram, and a state chart diagram; and an interface tag(204) for automatically loading a list of resource items once the resource items of a target are selected and executed.

Because an existing UML diagram is not for an embedded system, there exist partially unnecessary parts when being applied to the embedded system. Also, a UML has many diagrams through a complex structure, requiring a lot of time for its usage. Instead of using all diagrams of the existing UML diagram, the present invention employs the class diagram, the sequence diagram, and the state chart diagram only, in order to support completion and development of design with optimal diagrams by simplifying system design. With the above four diagrams, it is possible to express parts by separating them into a part dependent on a target and a part independent thereon.

The interface tag (204) is a mean for more easily and quickly generating the target independent model, indicating a profile name stated in a particular profile and being automatically loaded when the modeling tool is executed.

The interface tag(204) corresponds to a name tag for easily bringing, from an already-existing(that is, used for another product) profile, resources necessary for an embedded system to be developed by a designer, for instance, processor, sensor, and actuator items of a hardware item of FIG. 2, and more specifically, P_GPIO, P_ISR, P_Timer, P_Memory, P_UART and P_ADConverter items as model resources that abstract a processor used in the processor item, and for reusing the brought resources. Detailed data individually corresponding to hardware resources defined in each interface tag, that is, realization unit data for substantial reliazation of an embedded system of a new product is stored in a profile prepared/defined for the new product.

The designer can drag a particular desired interface tag with a mouse from the interface tag list (204), and add it to a writing screen(205) of the modeling tool. The writing screen(205) as an example of FIG. 2 selects the class diagram of the diagram tool (203), and drags and expresses ‘OS_SYNC’ and ‘OS_TASK’ resources of the automatically loaded interface tag according to selective execution of the class diagram.

In addition, the interface tag plays a role of generating a realization class for executing substantial driving of a particular target, when final conversion is performed into a target dependent model of the present invention through a model conversion process to be explained later. Detailed explanation will be done below.

When object-oriented programming is employed, expansion is available without a client's modification by separating a part independent on a target from a dependent part. The present invention uses such a design advantage to automatically generate a realization unit by profiling the part dependent on the particular target, so that problems of an existing method depending on a system designer's experience or ability can be solved through an automated method. Therefore, anyone can easily develop a system once learning a simple design method. Besides, since the system is configured by basically complying with design principles, maintenance can be easily done.

FIG. 3 is an embodiment of each diagram included in a modeling tool used when a target independent model and a target dependent model in accordance with the present invention are generated.

A usecase diagram(301) expresses a relation with a system based on a user, and clearly states how the system has to be performed. A class diagram(302) is a means for expressing a static structure of the system, being used the most. With the class diagram(302), a structure and functions of the system is and are defined, and responsibilities and roles of each class are divided while relation thereof is defined. A sequence diagram(303) dynamically represents messages transceived between objects of classes made by the class diagram(302), so as to express cooperation between the objects. A state chart diagram(304) shows a state action of one object, describing the action when the system is dynamically executed.

A method of preparing the four diagrams (the usecase, class, sequence and state chart diagrams) using a UML is a prior art, thus detailed explanations will be omitted.

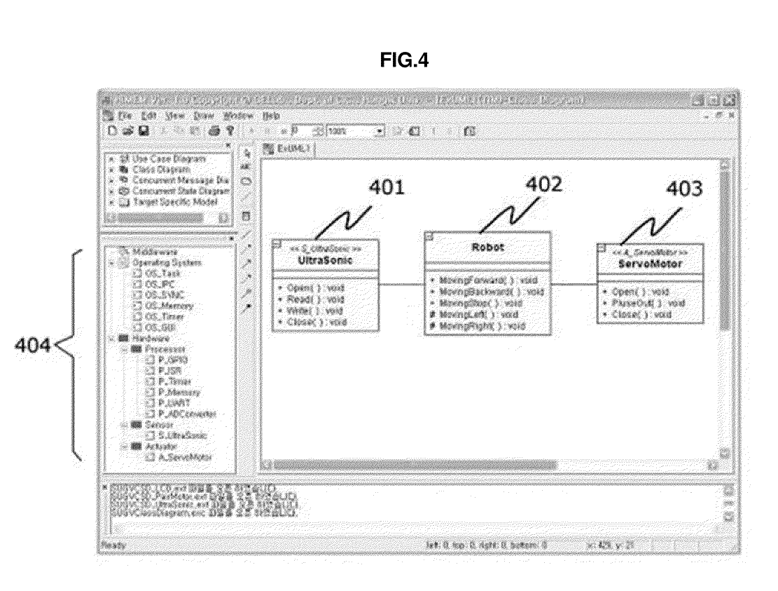

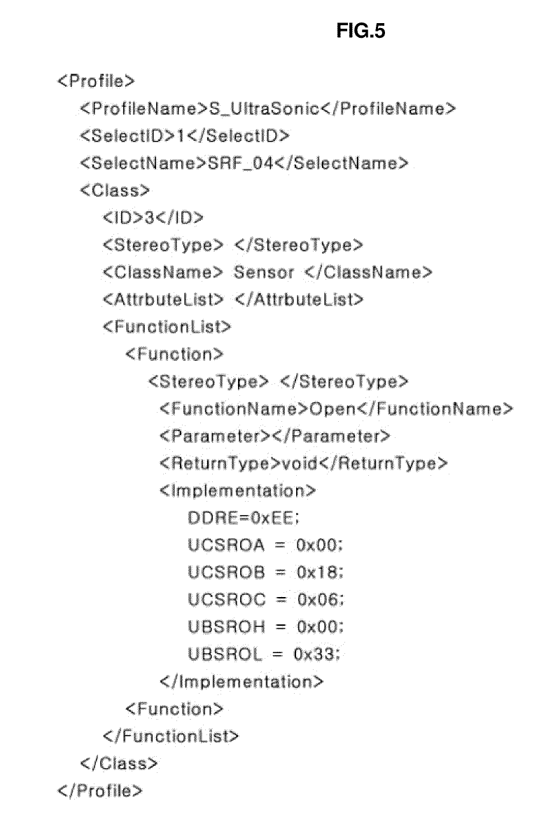

FIG. 4 is a diagram showing one example of a target independent model generated by using a class diagram of a modeling tool, for design of an embedded system to be built in a robot.

By referring to FIG. 4, according to the target independent model of the present invention expressed in the class diagram, when the embedded system to be built in a moving robot is to be designed, functions basically common to a product group called the robot would include going forward, going backward, stopping, and going right and left.

So, the functions such as going forward, going backward, going right and left, and stopping are defined in a robot class(402), and an ultrasonic sensor class (401) for avoiding an obstacle and a servo motor class(403) for driving motion are read from an interface tag(404) and expressed.

At this moment, since a designer does not have to consider detailed data contents for hardware control of a servo motor or an ultrasonic sensor, he or she can just consider an API (Application Programming Interface) capable of calling hardware control data contained in a profile.

In other words, according to the target independent model in accordance with the present invention, the designer can just read the ultrasonic sensor (401) and the servo motor (403) by using the interface tag(404) by only generating the robot class (402), because commonly necessary contents of products belonging to the same class are contained in a previously defined existing profile.

(2) The generated ‘target independent model’ is converted into a ‘model definition language’ (S200).

Through the aforementioned process, the ‘target independent model’ of the present invention expressed in picture type(UML diagram) is converted in linguistic expression.

When the target independent model is extracted/generated through the step ‘S100’, the modeling tool automatically converts the target independent model into a linguistic type and stores the converted model inside the modeling tool, in order to store information of the ‘target independent model’ expressed in UML diagram type, to perform a conversion work for inserting a detailed realization unit dependent on a newly developed product, and to present the converted model in the UML diagram type again. That the target independent model is expressed in a certain type of language for the above purpose is a ‘target independent model definition language’.

Another reason why the target independent model is converted into the target independent model definition language is because it is easier and more exact to convert the target independent model via a model definition language type rather than direct conversion into a target dependent model.

And, when a tool is developed, a model engine that draws a diagram of a target independent model can be separated from a compiler part taking charge of conversion, thus development is possible in module unit. Moreover, maintenance is also easy because the model engine and the model compiler are independently made.

Like one example of the ‘robot’ of FIG. 4, hereinafter, a detailed process of converting the ‘target independent model definition language’ into a ‘target dependent model definition language’ will be described as follows, according to one example of design of an embedded system built in the ‘robot.

Contents of the target independent model definition language are read by a sentence scanning process (FIG. 1; S210) and analyzed, then configured in meaning tree type. Meaning trees are divided by rules and definitions of written sentences, and are generated in tree structure which can configure and express data so that each item can be hierarchically connected together (FIG. 2; S220).

The above tree structure is classified into middleware, operating system, and hardware items.

The middleware item fills differences among various kinds of hardware, application programs, and operating systems, and is reserved for smooth communication between application programs and operating environments under heterogeneous environments.

The operating system item contains resources of the operating systems, and abstracts tasks, communication between the tasks, synchronization, memories, time, and graphics, then properly adds each operating system(OS). The operating system item of the embodiment of the ‘robot’ consists of ‘OS_Task’, ‘OS_IPC’, ‘OS_SYNC’, ‘OS_Memory’, ‘OS_Timer’ and ‘OS_GUI’.

The hardware item is classified again into processor, sensor, and actuator items. The processor item is a model resource for abstracting used processors, consisting of ‘P_GPIO’, ‘P_ISR’, ‘P_Timer’, ‘P_Memory’, ‘P_UART’ and ‘P_ADConverter’, and wherein functions such as input/output, interrupt, timer, memory, communication, and analog conversion are abstracted. The sensor item is an abstracting model resource of used sensors, and wherein all of the sensors take charge of external input/output functions. The actuator item contains information related to a device such as a motor for controlling motion of the robot.

When the tree structure is completed through the aforementioned process, resources to be converted are configured as sentence tables(FIG. 1; S230).

(3) A ‘middle language’ is generated(S300).

When the sentence table configuration(FIG. 1; S230) is finished, the middle language is generated(FIG. 1; S300). The middle language indicates a language generated by reading realization units of targets stored in a profile and inserting the read realization units into the target independent model definition language. Namely, the middle language refers to a type completed by filling the target independent model definition language with detailed contents of the realization units of the targets contained in the profile. Accordingly, the middle language is configured as a combination of the target independent model definition language and contents of the profile.

To generate the middle language by inserting the profile into the target independent model definition language, a profile table should be first formulated. The configuration of the profile table(FIG. 1; S250) is made by loading the profile(FIG. 1; S240).

When the defined profile is loaded on a memory to use the profile, parts having the same interface tag name at a sentence table and a name defined in the profile are combined together to generate the middle language(FIG. 1; S300).

Like shown in one example of FIG. 5, the profile means a file where detailed data on the realization units corresponding to each target defined in the interface tag(404 of FIG. 4) is stored, and more specifically, the profile comprises: a hardware profile unit for containing information on hardware; a middleware profile unit for containing information on middleware; and an operating system profile unit for containing information on an operating system.

Therefore, in the interface tag(404), a converter is operated when each title of the interface tag is matched with names defined at the profile table, then substantial conversion is carried out. Also, it is available to configure one interface tag to include various kinds of hardware, or one interface tag can consist of diverse profiles.

If a designer selects a particular target (that is, hardware, middleware or operating system item), detailed realization unit data corresponding to the selected target is generated through an automation process (namely, automatically generated when names of the profile and the interface tag are matched together).

Likewise, the profile contains a target independent code. Thus, the designer can operate hardware even without separately modifying a hardware control code in a target dependent model, which is a final conversion state of a target independent model design method of an embedded system in accordance with the present invention.

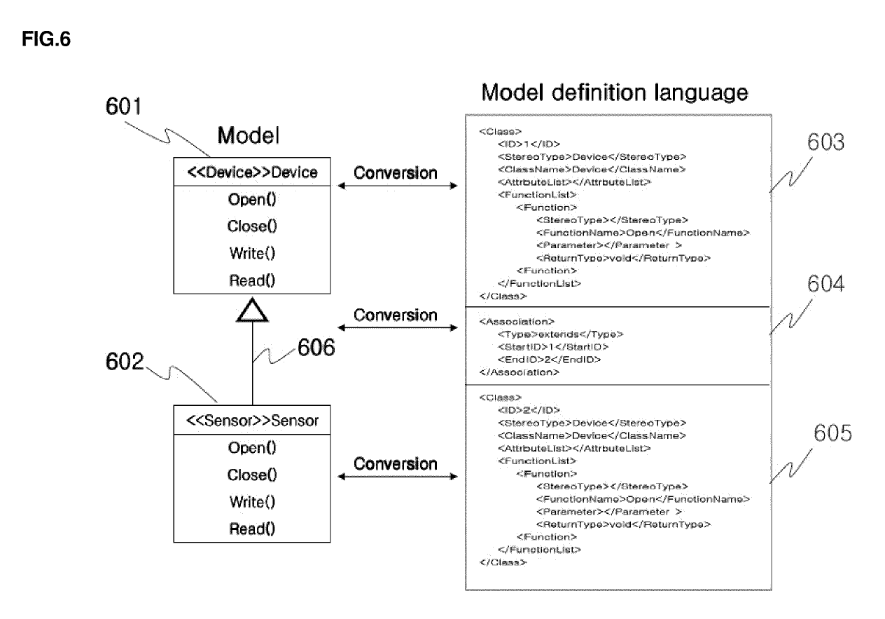

FIG. 6 is a diagram showing a figure that a particular model and a model definition language are mutually converted, to help understanding of the ‘model’ (that is, a form expressed in UML diagram) of the present invention and the ‘model definition language’ defined by representing the model in a linguistic way.

The model indicates a term ‘model’ used in the ‘target independent model’ and the ‘target dependent model’ of the present invention. And, the ‘model definition language’ indicates a term ‘model definition language’ used in the ‘target independent model definition language’ and the ‘target dependent model definition language’ of the present invention.

Referring to FIG. 6, a ‘Device’ class(601) and a successive ‘Sensor’ class (602) thereof can be converted into model definition languages(603, 604, 605), respectively, and the converted model definition languages can be converted into models(namely, UML diagrams) again.

The ‘model definition language’ of the reference number ‘603’ is a part that expresses a ‘model’ (that is, the ‘Device’ class) of the reference number ‘601’ in XML type, and consists of ‘ID’, ‘StereoType’, ‘ClassName’, ‘AttrbuteList’, and ‘FunctionList’. It is matched one to one with a ‘model’, that is, a class (the ‘Device’ class in FIG. 6) of the class diagram.

The ‘Sensor’ class(602) is also converted into the model definition language(605) in the same way as the ‘Device’ class(601).

Furthermore, a line(606) that presents relations between the ‘Device’ class and the ‘Sensor’ class of FIG. 6 can be expressed in the model definition language(604) like the reference number ‘604’. The model definition language(604) which shows the relations between the two classes(601,602) consists of ‘Type’, ‘StartID’, and ‘EndID’. The ‘Type’ is a kind of a line, being involved in succession, dependence, association, integration, and combination, while ‘StartID’ and ‘EndID’ are IDs of each class and express which class has a mutual relation.

Like mentioned in the above examples so far, the target independent model and the target dependent model in accordance with the present invention are converted and expressed in model languages, so that mutual conversion between the model languages and UML diagrams can be easily carried out. In other words, according to the above method, since a model compiler can just convert into model data from model data, functions of the compiler can be simplified.

(4) A ‘target dependent model definition language’ is generated(S500).

When generation of a middle language is finished through the above process, a ‘target dependent model definition language’ conversion step is next performed to generate a ‘target dependent model’ which is a final conversion type of a target independent model design method of an embedded system in accordance with the present invention.

The ‘target dependent model’ of the present invention is software applied by being dependent on a particular target only, being expressed in UML diagram like the target independent model. However, unlike the target independent model, it contains a target dependent code, and has data information of detailed realization units corresponding to each interface part of the target independent model, thereby substantially operating a particular target.

The ‘target dependent model definition language’ of the present invention indicates that picture types (that is, UML diagrams) of a target dependent model added with profile contents for specifically operating the target and a target dependent code which is not included in the ‘target independent model’ are presented in linguistic type such as the aforementioned model definition language.

The target dependent model definition language is generated by applying a conversion language to the middle language generated through the step ‘S300’.

The ‘conversion language’ of the present invention indicates a type completed by filling the target independent model with profile contents, that is to say, a language used when new contents are added to the middle language or the previously existing target independent model (namely, the target independent model used for an already-existing product) is reused and particular contents of the previously existing target independent model should be changed.

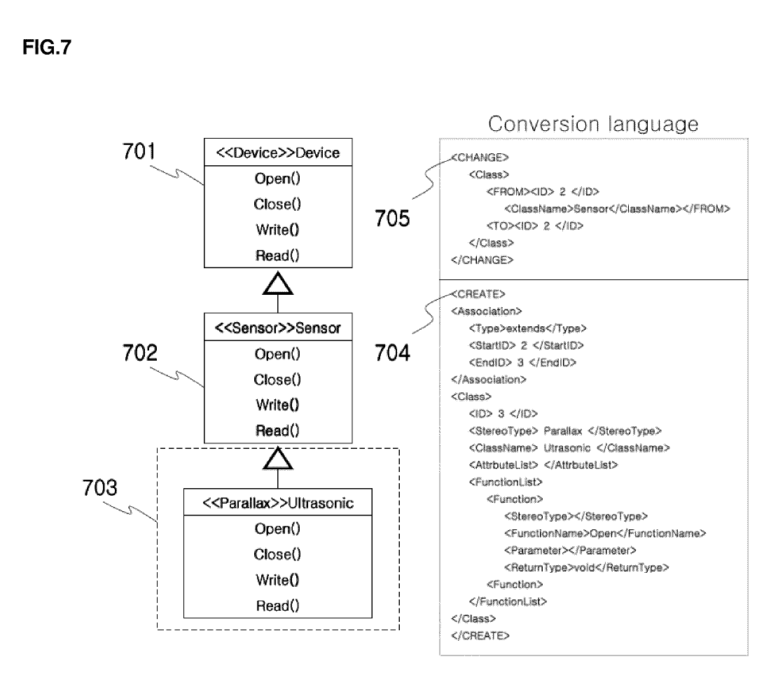

FIG. 7 is a diagram showing one example for applying a conversion language of the present invention. By referring to the example of FIG. 7, the conversion language consists of a ‘CREATE’ class and a ‘CHANGE’ class. A conversion language expressed in a reference number ‘704’ corresponds to the ‘CREATE’ class, while a conversion language expressed in a reference number ‘705’ corresponds to the ‘CHANGE’ class.

When a ‘Device’ class(701) and a ‘Sensor’ class(702) generated in class diagrams exist, a ‘Ultrasonic’ class(703) is additionally generated by the conversion language contained in the ‘CREATE’ class(704).

By using the ‘conversion language’ of the present invention, it can add contents and new classes which are not defined in the profile, to the middle language corresponding to a type completed by filling the target independent model with the profile contents, or can change particular contents, and help to expand a certain part hard to be marked in the profile.

Like mentioned above, if definition on the ‘conversion language’, where information to be changed or newly added to the ‘middle language’ of the step ‘S300’, is completed and prepared, the conversion language is loaded(S400), and apart to be converted through conversion rule analysis is extracted(S410), then the part is converted by being applied to the ‘middle language’ generated in the step ‘S300’ (S420).

The middle language finally converted via the conversion language application step of the steps(S400 to S420) is the very ‘target dependent model definition language’, which is a final conversion type of the present invention(S500).

When the ‘target dependent model definition language’ is completed, the target dependent model definition language is converted into a target dependent model expressed in UML diagram(S600), and the converted target dependent model can be usable by being converted into a designer's desired language again.

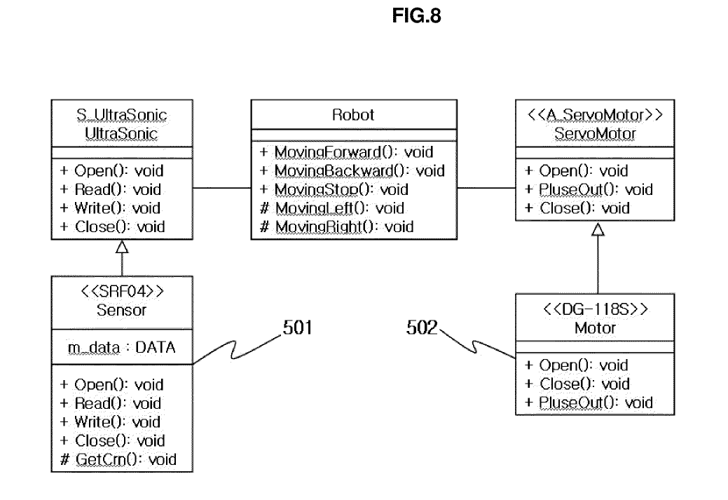

FIG. 8 is one example for expressing a target dependent model of an embedded system built in a robot, in UML diagram.

The target dependent model of FIG. 8 is a finally converted type of the target independent model presented in FIG. 4, via insertion steps(S240,S250) of hardware selected by a designer and a profile corresponding to the hardware and changing steps(S400,S410) of particular contents and addition of new contents through the conversion language.

Sensor(501) and Motor(502) items of FIG. 8 are automatically generated parts through a step(S240) of loading and reading the predefined profile and a step(S260) of inserting the read profile into the target independent model, rather than being directly written by a designer on a UML.

If an embedded system to be applied to a newly developed product from an already-existing product is to be designed, the designer can easily and quickly design the embedded system to be applied to another product without changing an existing code, by changing lower classes(501 and 502 of FIG. 8) only of the target dependent model and reusing upper classes(401,402, and 403 of FIG. 4) which constitute the target independent model.

The target dependent model finally generated through the steps S100 to S600 passes through the following steps, thereby substantially operating an embedded system built in a particular product.

That is to say, the target dependent model is converted into the target dependent model definition language, and the converted language is converted into text, that is, a particular program language by using templates suitable for each language(ex, C language, JAVA, etc.) desired by a designer(S700). Then, when the program language is compiled to generate a binary code(S800) and the binary code is mounted on the embedded system, a substantial operation of the system can be realized.

In addition, if new contents should be added after the above process is completed, the designer can very conveniently progress an embedded system design work by easily inserting the added contents with the use of the target dependent model of the present invention, and by changing the model into the target dependent model definition language again and generating a code from the target dependent model definition language.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An embedded system design device using a target independent model, comprising:
a target independent model expressed in UML diagram type as a resource, which extracts, abstracts, and expresses an upper concept that includes specific functions and contents individually represented in hardware, middleware, and an operating system(hereinafter, target) of a product;
a target independent model definition language for expressing the target independent model in language type, for conversion of the target independent model and data storage;
a profile where specific data for substantially controlling a particular embedded system is stored;
a middle language configured by inserting contents of the profile into the target independent model definition language;
a conversion language configured in the same linguistic type as the middle language, and for adding new data which does not exist in the middle language, or for changing particular contents;
a target dependent model definition language generated by applying the conversion language to the middle language;
a target dependent model for expressing the target dependent model definition language in UML diagram type; and
a modeling tool for performing a series of processing procedures of writing a diagram by using a UML (Unified Modeling Language), providing an interface tag which suggests resource items for extracting/generating the target independent model, and generating the target independent model to convert the independent model into the target dependent model.

2. The embedded system design device of claim 1, wherein the profile, comprising:
a hardware profile unit for containing information on hardware;
a middleware profile unit for containing information on middleware; and
an operating system profile unit for containing information on an operating system.

3. The embedded system design device of claim 1, wherein the diagram prepared through the modeling tool comprises a usecase diagram, a class diagram, a sequence diagram, and a state chart diagram.

4. An embedded system design method using a target independent model expressed in UML diagram type, as a resource for extracting, abstracting, and representing an upper concept that includes detailed functions and contents individually expressed in hardware, middleware, and an operating system(hereinafter, target) of a product, comprising the steps of:
a first step of generating the target independent model through a modeling tool consisting of interface tags, which write diagrams using a UML and array resource items necessary for targets of an embedded system mounted on a product to be developed by a designer;
a second step of converting the target independent model into a target independent model definition language configured in linguistic type, for conversion of the generated target independent model and data storage;
a third step of generating a tree structure by reading and analyzing contents of the converted target independent model definition language through a sentence scanning process, and of configuring the generated tree structure as a sentence table;
a fourth step of configuring a profile table by loading a profile, where detailed data for realization units individually corresponding to the target is stored, and of generating a middle language by applying the profile table to the sentence table;
a fifth step of generating a target dependent model definition language by loading a conversion language having information to be changed or newly added to the generated middle language, extracting a part to be converted through conversion rule analysis, and by applying the extracted part to the middle language; and
a sixth step of converting the target dependent model definition language into a target dependent model realized in UML diagram type.

5. The embedded system design method of claim 4, wherein when the target dependent model definition language is converted into a particular program language by using a template suitable for a designer's desired language and the program language is compiled to generate a binary code so that the binary code is mounted on an embedded system, a substantial operation of the system is realized.

6. The embedded system design method of claim 4, wherein the target independent model of the first step is expressed in a usecase diagram, a class diagram, a sequence diagram, and a state chart diagram using a UML.

7. The embedded system design method of claim 4, wherein the target independent model of the first step is generated by selectively dragging a particular interface tag with a mouse among the interface tags, and by adding the dragged tag to a writing screen of the modeling tool.

8. The embedded system design method of claim 4, wherein in the case of the middle language of the fourth step, a converter is operated when titles of each interface tag are matched with names defined at the profile table, and substantial conversion is carried out, so that detailed realization unit data corresponding to a particular target selected by the designer is automatically generated.

9. The embedded system design method of claim 4, wherein the conversion language consists of a ‘CREATE’ class and a ‘CHANGE’ class, and the ‘CREATE’ class adds new contents to the middle language while the ‘CHANGE’ class changes particular contents of the middle language.

10. The embedded system design method of claim 4, wherein the second step of converting the target independent model into the target independent model definition language configured in the linguistic type is performed as follows: when the target independent model is extracted/generated through the first step, the modeling tool automatically converts the target independent model into the linguistic type and stores the converted model inside the modeling tool.
